(19) United States
(12) Patent Application Publication
(10) Pub. No.: US 2002/0014960 A1
(43) Pub. Date: Feb. 7, 2002

(54) Illuminating light display apparatus for USB devices. A.K.A. PC/USB light device or flylight

(76) Inventor: Cecil Earl Williams JR., Lauderhill, FL (US)

Correspondence Address: CECIL E. WILLIAMS JR., 3171 LA MIRAGE DR., LAUDERHILL, FL, 33319, US

(21) Appl. No.: 09/682,279

(22) Filed: Aug. 13, 2001

(51) Int. Cl. G08B 23/00

(52) U.S. Cl. 340/500

(57) ABSTRACT

Solely pertains to achieving a light source using a standard Universal Serial Buss (USB) Device.

### CROSS REFERENCE TO RELATED APPLICATIONS

D,435,67912/26/00 Nyko D,238,95902/1976 Kurokawa D26/107 XD,251,68704/1979 Kurokawa D26/107 D,377,8 X4,312,50701/1982 Smith et al.. 5,091,83202/1992 Tortola et al.. 5,122,93706/1992 Stoudemire. 5,122,94106/19 al.. 5,136,47708/1992 Lemmey. 5,172,97412/9192 Riban. 5,183,32502/1993Hurdle.5,203,62204/1993 Sottile. 5,3 et al.. Patent Documents 113 81812/1981 United Kingdom. WO 92/0632704/1992WIPO.

### BACKGROUND OF INVENTION

The universal Serial Bus (“USB”) is specialized to be an industry standard expansion to the PC architecture or any computer device thereof. The USB architecture provides for ease of use of peripheral expansion. USB is a cable bus supporting simultaneously peripherals where one host controller can support up to 127 physical devices.

The invention is broadly concerned with Personal Computers, Internet Devices, Laptops, PlayStation 2 systems, USB Keyboard(s), Pocket PC and or Windows CE device that incorporate a USB Port. One particular difficulty noted with regard to such devices is the lack of an appropriate light source. This can be a particular hardship in such locations wherein auxiliary lamps or the like are not normally available.

Because these devices are normally used in the day, their manufactures have conventionally made no provisions for incorporating a light source in these devices because of their complexity and/or cost factor to do so.

### SUMMARY OF INVENTION

This Illuminating light display apparatus for any USB device overcomes the problems associate with prior art by not incorporating a power source such as Batteries or AC Power Supply, instead it simplifies the process by attaching a simple light source to any standard USB connector for it's power source. Another key element of the design is a flexible, thinned, bendable stabilizing agent. Because of this compact light USB design (as illustrated) the unit is adaptable beyond portable devices and by lengthening the standard USB cable (102) it becomes fully functional also in any standard USB desktop device. The invention also has an on/off switch (not required), which facilitates the end user a quick option to turn on/off the unit.

### BRIEF DESCRIPTION OF DRAWINGS

For a more complete understanding of the present invention, and the advantages thereof, reference is now made to the following descriptions taken in conjunction with the accompanying drawings, in which:

FIG. 1 Illustrates a perspective view of a illuminating light attachment for Personal Computers, Internet Devices, Laptops, PlayStation 2 systems, USB Keyboard(s), Pocket PC and or Windows CE device in other words any electronic device that incorporates a USB Port; FIG. 1 a Illustrates an internal mechanical view of a standard USB wire without any modifications set forth. This is used for illustrative demographics comparison example to FIG. 2a only and forms no part of the claimed design.

FIG. 2 Illustrates a side elevation view thereof, the opposite side being a mirror image; FIG. 2a Illustrates a internal mechanical view of a standard USB wire with modifications primarily and only with the exception of a flexible thinned copper stabilizing shield agent.

FIG. 2a when compared to FIG. 1 a illustrates explicitly the minor modifications to the internal wiring components of a standard USB wire to facilitate the present invention.

This example is one of the several possible variations, for flexible thinned stabilization, which is added to any a standard USB wire to facilitate the light source invention. Again for the most part specifics details concerning each wiring configuration along with the length for a standard USB wires harness is set forth in USB Specifications, and is beyond the scope of this invention and thus therefore is truncated. Note: Another significant possible decorative design variant, which has not been illustrated, is a blinking track light like variation which extends the length of the variable standard USB wire (this decretive design add on serve no functional advantage to the invention, but can be a significant marketing advantage).

FIG. 3 Illustrates a top plan view thereof;

FIG. 4 Illustrates a front elevation view thereof;

FIG. 5 Illustrates a rear elevation view thereof;

FIG. 6 Illustrates a bottom plan view thereof;

FIG. 7a Illustrates a perspective view of the Illuminating USB light attachment for any USB device, shown as used on a USB PC Laptop.

FIG. 7b Illustrates a front elevation view of the illuminating USB light attachment for any USB device, shown as used on a USB Keyboard.

The broken lines showing in FIG. 7a & FIG. 7b are for illustrative demographics example of usage purposes only and form no part of the claimed design.

FIG. 8 Illustrates a perspective view of a second embodiment of the Illuminating USB Light attachment.

FIG. 9 is a side elevation view thereof, the opposite side being a mirror image; This invention facilitates portable lighting to end users, using a Universal Serial Bus (USB) as a source of power to the illuminating light. The light device does not restrain itself to portability devices however, even though it has a compact design. It expands it versatility to the desktop personal computer or the new Internet devices by using a device like the “USB Keyboards” to facilitate keyboard or desktop lighting. In addition, by increasing the length of the device (102) the user can use the device like a desk lamp.

### DETAILED DESCRIPTION

In the following description, for the most part, specific details are presented concerning the length of the standard USB wire (102) along with the on/off switch (103), which is an optional part of the light source (104). Please note specific detail components have been omitted so as much as such detailed are not necessary, to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

Within the following description, a standard universal serial bus connector (101), all refer to the USB architecture described within the “Universal Serial Bus Specifications”.

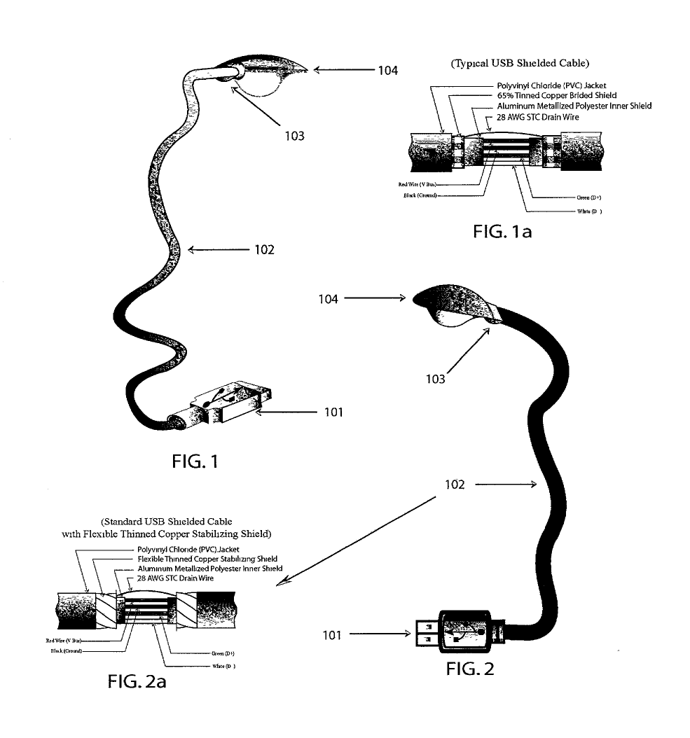

The Illuminating Light Display Apparatus (FIG. 1) used the standard USB connector (101) as a power source for it light (104), it is a simple light source device (104), which conforms to the USB standards.

The specific components are as follows (from bottom up): Referring now to FIG. 1 one standard USB (Universal Serial Buss) connector (101). One (variable length) standard USB wire configured with a flexible thinned bendable, stabilizing agent (102). A on/off switch (which is not required, a optional configuration) which give the end user a friendly quick option to turn off/on the unit (103). A illuminating light source with shielding which provides the user with a source of light (104).

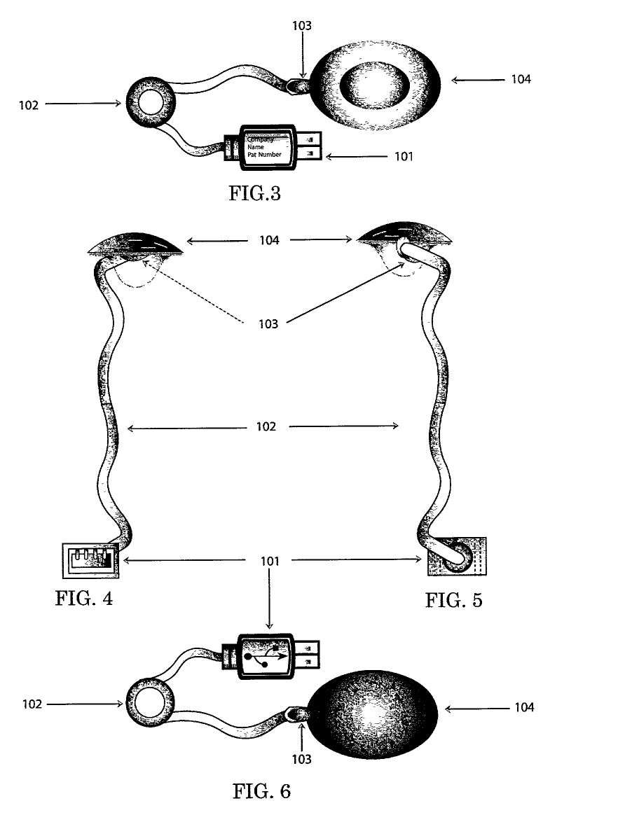

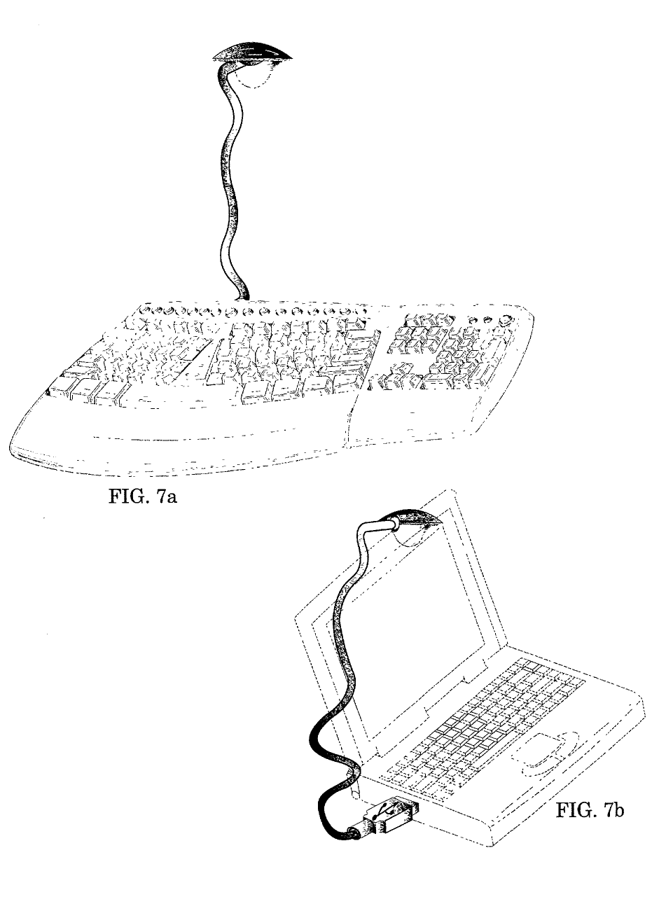

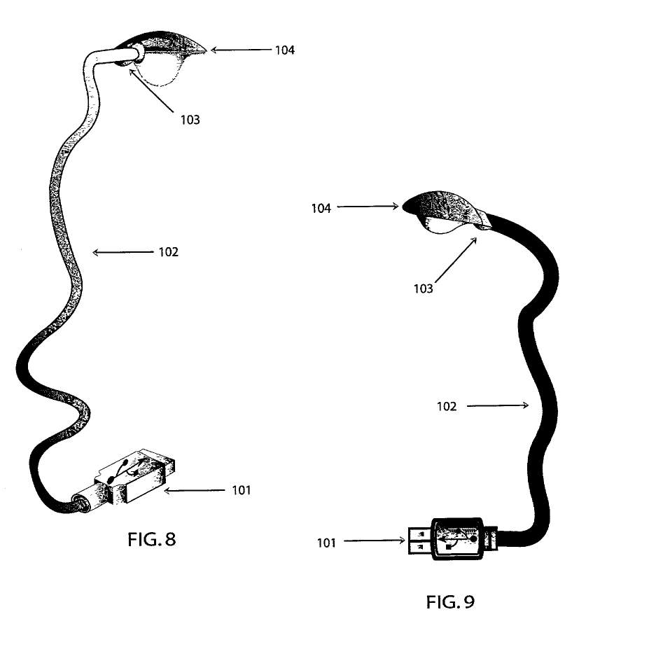

These specific components are assembled in this order: The standard USB connector (101) is connected to the (variable length) standard USB wire configured with a bendable yet flexible thinned, stabilizing agent (102) & (FIG. 2a). This now modified USB wire is then connected to an illuminating light source (104) with proactive shielding which may or may not incorporate a on/off switch.

The process of using this invention is as simple as using any standard Universal Serial Bus device. As simple as plugging in a telephone jack, that's the simplicity of the USB Standards and this invention complies with this philosophy wholly with it's standard USB attachment (101) just plug it in and the illuminating light attachment (104) will comes on and start working, the universal serial bus wire (102) with the optional flexible thinned, stabilizing agent (102) & (FIG. 2a) give the user a easy way to twist and turn the invention's illuminating light source (104) in any direction the user please. Finally, the optional on/off switch (103) gives the end user yet another quick way to turn on/off the invention.

Please note a regulating +5 volts is provided and controlled by the USB apparatus (regulated by the USB standards) witch the invention is attached to, using the standard USB connector (101). So no particular configuration is necessary for the light source attachment such a surge protector.

I claim as my invention is:

1. The ornamental designed for an Illuminating light attachment for any standard Universal Serial Buss (USB) device apparatus, as shown and described.
